(19) United States
(12) Patent Application Publication
(10) Pub. No.: US 2012/0275564 A1
(43) Pub. Date: Nov. 1, 2012

(54) RADIATION IMAGING APPARATUS

(75) Inventor: Atsushi HASHIMOTO, Kanagawa (JP)

(73) Assignee: FUJIFILM CORPORATION, Tokyo (JP)

(21) Appl. No.: 13/454,766

(22) Filed: Apr. 24, 2012

(30) Foreign Application Priority Data
Apr. 26, 2011 (JP) 2011-098273
Dec. 2, 2011 (JP) 2011-264691

(51) Int. Cl. G01N 23/04

(52) U.S. Cl. 378/62

(57) ABSTRACT

An X-ray imaging apparatus has first and second gratings, an X-ray image detector, and a differential phase image production section. The first grating passes X-rays emitted from an X-ray source to produce a first periodic pattern (G1 image). The second grating is disposed in a rotated state while being kept in parallel with the first grating. The second grating partly shields the G1 image to produce a second periodic pattern image (G2 image) with moiré fringes. The X-ray image detector detects the G2 image to produce image data. The differential phase image production section produces a differential phase image based on the image data. The X-ray image detector has a difference in sharpness between two orthogonal directions within its detection surface, and is disposed such that one of the directions with the high sharpness crosses the moiré fringes.

### BACKGROUND OF THE INVENTION

1. Field of the Invention

The present invention relates to a radiation imaging apparatus for obtaining an image based on a phase change of radiation caused by a subject.

2. Description Related to the Prior Art

When radiation, for example, X-rays traverse a substance, the X-rays attenuate depending on weight (atomic number) of an element constituting the substance, and density and thickness of the substance. Because of this property, the X-rays are used as a probe for inspecting inside of a subject in conducting medical diagnoses and non-destructive inspections.

A common X-ray imaging apparatus has an X-ray source for emitting X-rays and an X-ray image detector for detecting the X-rays. A subject is placed between the X-ray source and the X-ray image detector. The X-rays emitted from the X-ray source attenuate due to absorption by the subject, and then are incident on the X-ray image detector. Thereby, the X-ray image detector detects an image based on intensity changes of the X-rays caused by absorption power of the subject.

The smaller the atomic number of the element, the lower the X-ray absorption power. Because the intensity changes of the X-rays caused by living soft tissue and soft matter are small, their images do not have much contrast. For example, a cartilaginous part of a human joint and synovial fluid surrounding the cartilaginous part are composed mostly of water. Accordingly, a difference in X-ray absorption power between the cartilaginous part and the synovial fluid is small, resulting in poor contrast of the image.

To solve the problem, recently, X-ray phase imaging has been researched actively. The X-ray phase imaging obtains images based on phase changes, instead of the intensity changes, of the X-rays caused by the subject. The X-ray phase imaging is a technique to image the phase changes of the X-rays incident on the subject, based on the fact that the phase changes are more apparent than the intensity changes. Using this technique, an image of the subject with low X-ray absorption power is captured with high contrast.

An X-ray imaging apparatus enabling the X-ray phase imaging is suggested in Japanese Patent Laid-Open Publication No. 2008-200361, for example. In this apparatus, first and second gratings are arranged in parallel with each other at a given interval, between an X-ray source and an X-ray image detector. The X-ray image detector captures a moiré image of the X-rays emitted from the X-ray source and passed through the first and second gratings. Thereby, a phase contrast image is obtained.

The X-ray imaging apparatus disclosed in Japanese Patent Laid-Open Publication No. 2008-200361 utilizes a fringe scanning method. In the fringe scanning method, the second grating is moved relative to the first grating intermittently for a distance smaller than a grating pitch in a direction perpendicular to a grating direction. After each move of the second grating, a moiré image is captured while the second grating is still. Thereby, two or more frames of the moiré images are obtained. Based on the frames of the moiré images, an amount of the phase change of the X-rays, caused by interaction with the subject, is detected. Thereby, a differential phase image is produced. By integrating the differential phase image, a phase contrast image is produced.

The fringe scanning method requires a grating moving mechanism with high precision to move the first or second grating accurately at a pitch smaller than its grating pitch. This makes the apparatus complex and incurs high cost. In addition, the fringe scanning method requires capturing the two or more frames of images to produce the single phase contrast image. When the subject moves or the apparatus shakes during the successive image captures, the positions of the subject and the gratings may shift between the frames. This causes deterioration in image quality of the differential phase image. The Japanese Patent Laid-Open Publication No. 2008-200361, on the other hand, refers to producing a differential phase image from a single frame of moiré image obtained by a single image capture without moving the first and second gratings. However, a specific method is not disclosed.

U.S. Patent Application Publication No. 2011/0158493 (corresponding to WO2010/050483) suggests a Fourier transform method. In this method, a single frame of moiré image is obtained by a single image capture without moving the first and second gratings. Then, the moiré image is subjected to Fourier transform, extraction of a spectrum corresponding to a carrier frequency, and inverse Fourier transform. Thereby, a phase differential image is obtained.

The U.S. Patent Application Publication No. 2011/0158493, however, does not disclose a dispositional relation between the direction of the moiré fringes of the moiré image and the X-ray image detector. There is an X-ray image detector with a difference in sharpness between two orthogonal directions within its detection surface, for example, an optical-reading type X-ray image detector as disclosed in U.S. Patent Application Publication No. 2009/0110144 (corresponding to Japanese Patent Laid-Open Publication No. 2009-133823), an imaging plate, or the like. When the differential phase image is produced by spatial resolution of the single frame of moiré image using the Fourier transform or the like as disclosed in the U.S. Patent Application Publication No. 2011/0158493, and the moiré image is captured with the X-ray image detector having the difference in sharpness between the two orthogonal directions within its detection surface, an S/N of the differential phase image decreases depending on a relation between anisotropy of the sharpness and a direction of the spatial resolution.

### SUMMARY OF THE INVENTION

An object of the present invention is to provide a radiation imaging apparatus for improving an S/N of a differential phase image produced using a single frame of moiré image captured by a radiation image detector with a difference in sharpness between two orthogonal directions within its detection surface.

To achieve the above and other objects, the radiation imaging apparatus of the present invention includes a first grating, a second grating, a radiation image detector, and a differential phase image production section. The first grating passes radiation, from a radiation source, to generate a first periodic pattern image. The second grating faces the first grating. The second grating partly shields the first periodic pattern image to generate a second periodic pattern image with moiré fringes. The radiation image detector has a plurality of pixels arranged in a plane with a first direction and a second direction orthogonal to each other. The radiation image detector detects the second periodic pattern image, using the pixels, to produce image data. The radiation image detector is disposed such that the first direction with high sharpness crosses the moiré fringes. A differential phase image production section produces a differential phase image based on the image data.

It is preferable that the radiation image detector is of an optical reading type, having a linear reading light source extending in the first direction, for reading charge, accumulated in each pixel arranged in the first direction, being a pixel value of one line, with the use of the linear reading light source that scans in the second direction orthogonal to the first direction.

It is preferable that the differential phase image production section uses the predetermined number of the pixels arranged in the first direction as a group and shifts the group by one or more pixels at a time in the first direction to calculate phase of an intensity modulated signal, composed of the pixel values in each group, to produce the differential phase image.

It is preferable that the group is shifted by one pixel.

It is preferable that the number of the pixels constituting the group is equivalent to an integral multiple of the number of pixels corresponding to a single period of the moiré fringes.

It is preferable that the number of the pixels constituting the group is equivalent to the number of pixels corresponding to the single period of the moiré fringes.

It is preferable that the number of the pixels constituting the group is less than the number of pixels corresponding to a single period of the moiré fringes.

It is preferable that the differential phase image production section performs Fourier transform, extraction of a spectrum corresponding to a carrier frequency, and inverse Fourier transform to the image data to produce the differential phase image.

It is preferable that the moiré fringes are generated by placing the second grating in a rotated state relative to the first grating, while a grating surface of the second grating is kept in parallel with the first grating, and the moiré fringes are substantially orthogonal to grating directions of the first and second gratings.

It is preferable that the moiré fringes are generated by adjusting a distance between the first grating and the radiation source and a distance between the second grating and the radiation source, or a grating pitch of each of the first and second gratings, and the moiré fringes are substantially in parallel with a grating direction of the first and second gratings.

It is preferable that the moiré fringes are generated by placing the second grating in a rotated state relative to the first grating, while a grating surface of the second grating is kept in parallel with the first grating, and by adjusting a positional relation between the first and second gratings in a facing direction, or by adjusting a grating pitch of each of the first and second gratings, and the moiré fringes are not orthogonal to and not in parallel with grating directions of the first and second gratings.

It is preferable that the radiation imaging apparatus further includes a phase contrast image production section for integrating the differential phase image, in a direction substantially orthogonal to grating directions of the first and second gratings, to produce a phase contrast image.

It is preferable that the radiation imaging apparatus further includes a correction image storage section and a correction processor. The correction image storage stores a differential phase image, produced based on the image data obtained without the subject, as a correction image. The correction processor subtracts the correction image from the differential phase image produced based on the image data obtained with the subject.

It is preferable that the radiation imaging apparatus further includes a phase contrast image producing section for integrating a corrected differential phase image, corrected by the correction processor, in a direction substantially orthogonal to grating directions of the first and second gratings to produce the phase contrast image.

It is preferable that the first grating is an absorption grating and the first grating projects the incident radiation to the second grating in a geometrical-optical manner to generate the first periodic pattern image.

It is preferable that the first grating is an absorption grating or a phase grating for producing Talbot effect so that the incident radiation generates the first periodic pattern image.

It is preferable that the radiation imaging apparatus further includes a multi-slit disposed between the radiation source and the first grating. The multi-slit partly shields the radiation to disperse a focal point.

According to the present invention, the radiation image detector is disposed such that one of its directions with the high sharpness crosses the moiré fringes. This improves the contrast of the moiré fringes detected by the radiation image detector. As a result, the S/N of the differential phase image improves.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram of an X-ray imaging apparatus;

FIG. 2 is a schematic perspective view of an X-ray image detector;

FIG. 3 is a first explanatory view of an operation of the X-ray image detector;

FIG. 4 is a second explanatory view of the operation of the X-ray image detector;

FIG. 5 is a third explanatory view of the operation of the X-ray image detector;

FIG. 6 is a graph showing a relation between an MTF of the X-ray image detector and a spatial frequency;

FIG. 7 is an explanatory view of first and second gratings;

FIG. 8 is an explanatory view of a positional relation between the first and second gratings relative to pixels of the X-ray image detector;

FIG. 9 is an explanatory view of a group of the pixels constituting an intensity modulated signal;

FIG. 10 is a graph of the intensity modulated signal;

FIG. 11 is a block diagram of an image processor;

FIG. 12 is an explanatory view of a method for setting and shifting the group in calculation of a differential phase value;

FIG. 13 is an explanatory view of a first modified example of the method for setting the group;

FIG. 14 is an explanatory view of a second modified example of the method for setting the group;

FIG. 15 is an explanatory view of a third modified example of the method for setting the group;

FIG. 16 is an explanatory view of a modified example of a method for setting and shifting the group;

FIG. 17 is an explanatory view of a dispositional relation between the first and second gratings relative to the pixels of the X-ray image detector in a second embodiment;

FIG. 18 is an explanatory view showing directions of the X-ray image detector in the second embodiment;

FIG. 19 is an explanatory view of a method for setting and shifting the group in calculating the differential phase value in the second embodiment; and

FIG. 20 is an explanatory view of an X-ray image detector of a third embodiment.

### DESCRIPTION OF THE PREFERRED EMBODIMENTS

### First Embodiment

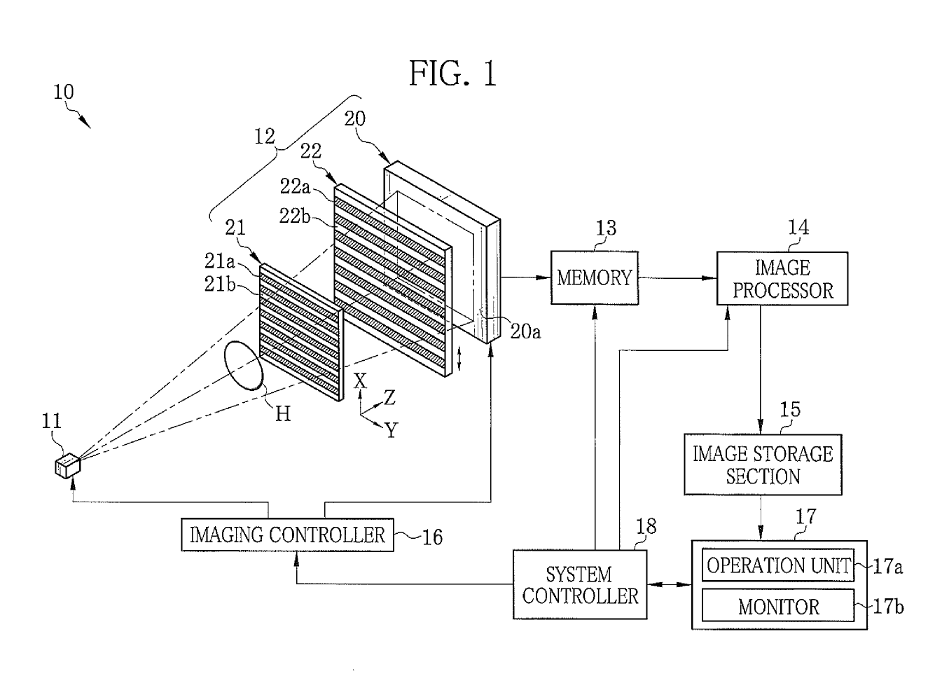

In FIG. 1, a radiation imaging apparatus, for example, an x-ray imaging apparatus 10 is provided with an x-ray source 11, an imaging section 12, a memory 13, an image processor 14, an image storage section 15, an imaging controller 16, a console 17, and a system controller 18. The x-ray source 11 has a rotating anode type X-ray tube (not shown) and a collimator (not shown) for limiting an X-ray field, as is well known. The X-ray source 11 emits X-rays to a subject H.

The imaging section 12 is provided with an X-ray image detector 20, a first grating 21, and a second grating 22. The first and second gratings 21 and 22 are absorption gratings and face the X-ray source 11 in Z direction being an X-ray emission direction. Between the X-ray source 11 and the first grating 21, there is a space for placing the subject H. The X-ray image detector 20 is an optical reading type flat panel detector. The X-ray image detector 20 is disposed behind and close to the second grating 22. A detection surface 20a of the X-ray image detector 20 is orthogonal to the Z direction.

The first grating 21 is provided with a plurality of X-ray absorbing portions 21a and a plurality of X-ray transmitting portions 21b both extending in Y direction in an XY plane (grating plane) orthogonal to the Z direction. The X-ray absorbing portions 21a and the X-ray transmitting portions 21b are arranged alternately in X direction orthogonal to Z and Y directions, forming a stripe-like pattern. As with the first grating 21, the second grating 22 is provided with a plurality of X-ray absorbing portions 22a and a plurality of X-ray transmitting portions 22b both extending in the Y direction, and arranged alternately in the X direction. The X-ray absorbing portions 21a and 22a are formed of metal with X-ray absorption properties, for example, gold (Au), platinum (Pt), or the like. The X-ray transmitting portions 21b and 22b are formed of an X-ray transmissive material such as silicon (Si) or resin, or simply gaps.

A part of the X-rays emitted from the X-ray source 11 passes through the first grating 21 to generate a first periodic pattern image (hereinafter referred to as the G1 image). The second grating 22 passes a part of the G1 image to generate a second periodic pattern image (hereinafter referred to as the G2 image). The G1 image substantially coincides with a grating pattern of the second grating 22. The first grating 21 is inclined slightly about a Z axis (in the direction within a grating plane) relative to the second grating 22, which will be described later. The G2 image has moiré fringes with a period corresponding to the inclination angle.

The X-ray image detector 20 detects the G2 image to produce image data. The memory 13 temporarily stores the image data read out from the X-ray image detector 20. The image processor 14 produces a differential phase image based on the image data stored in the memory 13, and a phase contrast image based on the differential phase image. The image storage section 15 stores the differential phase image and the phase contrast image. The imaging controller 16 controls the X-ray source 11 and the imaging section 12.

The console 17 is provided with an operation unit 17a and a monitor 17b. The operation unit 17a is used for setting imaging conditions, switching between imaging modes, and commanding image capture, for example. The monitor 17b displays imaging information and image(s) such as the differential phase image and the phase contrast image. The imaging modes include a preliminary mode and an imaging mode. In the preliminary mode, an image is captured without the subject H (hereinafter may referred to as the preliminary imaging). In the imaging mode, an image is captured with the subject H placed between the X-ray source 11 and the first grating 21 (hereinafter may referred to as the actual imaging). The system controller 18 controls each section in response to a signal inputted from the operation unit 17a.

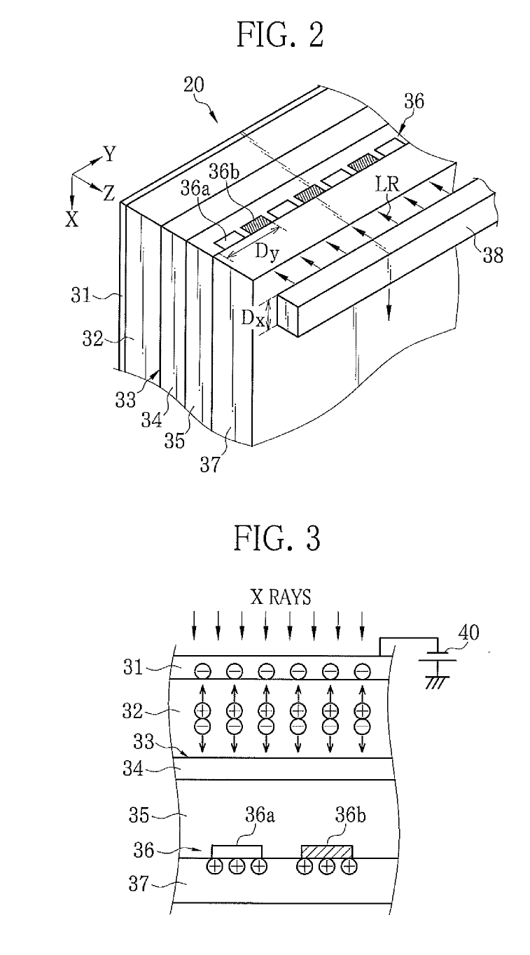

In FIG. 2, the X-ray image detector 20 is provided with a first electrode layer 31, a recording photoconductive layer 32, a charge transport layer 34, a reading photoconductive layer 35, and a second electrode layer 36, in this order from the top. The first electrode layer 31 passes the incident X-rays. The recording photoconductive layer 32 receives the X-rays passed through the first electrode layer 31 to generate electric charge. To the electric charge generated in the recording photoconductive layer 32, the charge transport layer 34 acts as an insulator to the electric charge of a polarity and as a conductor to the electric charge of the opposite polarity. The reading photoconductive layer 35 receives reading light LR to generate electric charge.

A capacitor portion 33 is formed at around an interface between the recording photoconductive layer 32 and the charge transport layer 34. The capacitor portion 33 stores the electric charge generated in the recording photoconductive layer 32. Note that the layers are in the above-mentioned order with the second electrode layer 36 formed on a glass substrate 37.

The first electrode layer 31 passes the X-rays. The first electrode layer 31 is, for example, a NESA film (SnO₂), ITO (Indium Tin Oxide), IZO (Indium Zinc Oxide), or IDIXO (Idemitsu Indium X-metal Oxide, a product of Idemitsu Kosan Co., Ltd.), being an amorphous light-transmissive oxide film, with the thickness of 50 nm to 200 nm. Alternatively, Al or Au with the thickness of 100 nm may be used.

Any substance which receives the X-rays to generate the electric charge can be used for the recording photoconductive layer 32. In this embodiment, a substance containing amorphous selenium as a main component is used, having advantage in relatively high quantum efficiency and high dark resistance. The appropriate thickness of the recording photoconductive layer 32 is from 10 μm to 1500 μm. For mammography, the thickness of the recording photoconductive layer 32 is preferably from 150 μm to 250 μm. For general radiography, the thickness of the recording photoconductive layer 32 is preferably from 500 μm to 1200 μm.

The greater a difference between mobility of charge charged in the first electrode layer 31 and mobility of charge of reverse polarity, the better the charge transport layer 34, when the X-ray image is recorded. For example, an organic compound such as poly(N-vinyl carbazole) (PVK), N, N′-diphenyl-N, N′-bis(3-methylphenyl)-[1, 1′-biphenyl]-4, 4′-diamine (TPD), or discotic liquid crystal, polymer (polycarbonate, polystyrene, or PVK) dispersion of TPD, a semiconductor material such as a-Se or As₂Se₃, doped with 10 ppm to 200 ppm of Cl, are suitable. The appropriate thickness of the charge transport layer 34 is of the order of 0.2 μm to 2 μm.

Any substance which receives the reading light LR to exhibit conductivity can be used for the reading photoconductive layer 35. It is suitable to use a photoconductive substance having at least one of the following as amain component: for example, a-Se, Se—Te, Se—As—Te, metal-free phthalocyanine, metal phthalocyanine, MgPc (Magnesium phthalocyanine), VoPc (phase II of Vanadyl phthalocyanine), and CuPc (Cupper phthalocyanine). The appropriate thickness of the reading photoconductive layer 35 is of the order of 5 μm to 20 μm.

The second electrode layer 36 has a plurality of transparent linear electrodes 36a and a plurality of light-shielding linear electrodes 36b. The transparent linear electrodes 36a pass the reading light LR. The light-shielding linear electrodes 36b shield or absorb the reading light LR. The transparent linear electrodes 36a and the light-shielding linear electrodes 36b extend linearly in the X direction from end to end of an image forming area of the X-ray image detector 20. The transparent linear electrodes 36a and the light-shielding linear electrodes 36b are arranged alternately and in parallel with each other in the Y direction at regular intervals.

The transparent linear electrode 36a is made from a material which has conductivity and transmits the reading light LR, for example, ITO, IZO, or IDIXO, similar to the first electrode layer 31. The thickness of the transparent linear electrode 36a is of the order of 100 nm to 200 nm.

The light-shielding linear electrode 36b is made from a material which has conductivity and shields or absorbs the reading light LR. For example, a combination of the above-described transparent conductive material and a color filter can be used. The thickness of the transparent conductive material is the order of 100 nm to 200 nm.

In the X-ray image detector 20, a pair of the adjacent transparent linear electrode 36a and light-shielding linear electrode 36b determines a pixel size Dy (hereinafter referred to as the main pixel size Dy) in the Y direction.

The X-ray image detector 20 is provided with a linear reading light source 38 that extends in the Y direction orthogonal to the extending direction of the transparent linear electrodes 36a and the light-shielding linear electrodes 36b. The linear reading light source 38 is composed of a light source such as an LED (Light Emitting Diode) or an LD (Laser Diode) and an optical system. The linear reading light source 38 emits linear reading light LR to the glass substrate 37. A moving mechanism (not shown) moves the linear reading light source 38 in the X direction being the extending direction of the transparent linear electrodes 36a and the light-shielding linear electrodes 36b. The electric charge is read out using the linear reading light LR from the linear reading light source 38. A width of the linear reading light source 38 in the X direction determines the pixel size Dx (hereinafter, referred to as the sub-pixel size Dx) in the X direction.

Unlike a flat panel, pixels are not sectioned separately in the X-ray image detector 20. However, with the use of the transparent and light-shielding linear electrodes 36a and 36b and the linear reading light source 38, the detection surface 20a is sectioned into read-out units each with the size DxxDy, which substantially correspond to the pixels.

As shown in FIG. 5, a read-out circuit 41 is provided to each pair of the transparent and light-shielding linear electrodes 36a and 36b. Each read-out circuit 41 has an integrating amplifier 41a with positive and negative input terminals. The negative input terminal is connected to the transparent linear electrode 36a and the positive input terminal is connected to the light-shielding linear electrode 36b.

Next, image detection and reading with the use of the X-ray image detector 20 are described. First, as shown in FIG. 3, a high voltage power supply 40 keeps applying negative voltage to the first electrode layer 31 of the X-ray image detector 20. The X-rays, emitted from the X-ray source 11 and passed through the first and second gratings 21 and 22, being the G2 image, are incident on the first electrode layer 31 of the X-ray image detector 20.

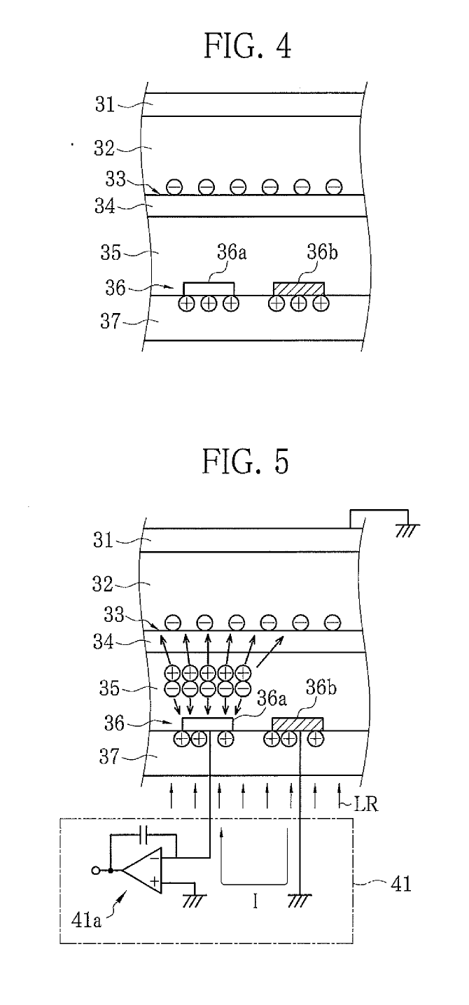

The X-rays incident on the first electrode layer 31 of the X-ray image detector 20 pass through the first electrode layer 31, and then are incident on the recording photoconductive layer 32. Thereby, the recording photoconductive layer 32 generates charge pairs. Of the charge pairs, positive charge (a positive hole) bonds with negative charge (an electron) charged in the first electrode layer 31 to cancel each other. As shown in FIG. 4, the negative charge, being latent image charge, is accumulated in the capacitor portion 33 formed at the interface between the recording photoconductive layer 32 and the charge transport layer 34.

Next, as shown in FIG. 5, with the first electrode layer 31 grounded, the linear reading light LR from the linear reading light source 38 is incident on the glass substrate 37. The reading light LR passes through the glass substrate 37 and then the transparent linear electrode 36a. Thereafter, the reading light LR is incident on the reading photoconductive layer 35. Thereby, the positive charge is generated in the reading photoconductive layer 35. The positive charge passes through the charge transport layer 34 and bonds with the latent image charge in the capacitor portion 33, while the negative charge bonds with the positive charge charged in the light-shielding linear electrode 36b through the integrating amplifier 41a connected to the transparent linear electrode 36a.

When the negative charge generated in the reading photoconductive layer 35 bonds with the positive charge charged in the light-shielding linear electrode 36b, a current “I” flows in the integrating amplifier 41a. The current I is integrated and then outputted as a pixel signal.

Thereafter, the linear reading light source 38 moves in the X direction at intervals of the sub-pixel size Dx. After each move of the linear reading light source 38, the above-described charge reading operation is performed. Thereby, the pixel signal is detected from each pixel of a line to which the linear reading light LR is applied. The pixel signals are detected on a line by line basis. The pixel signal of each pixel of the line is outputted from the corresponding integrating amplifier 41a. The pixel signals of the respective integrating amplifiers 41a are taken out one after another to form a time-series image signal of the line.

The image signal of each line is subjected to A/D conversion in an A/D converter (not shown), and then dark current correction, gain correction, linearity correction, and the like in a correction circuit (not shown), and thereafter inputted as the digital image data to the memory 13.

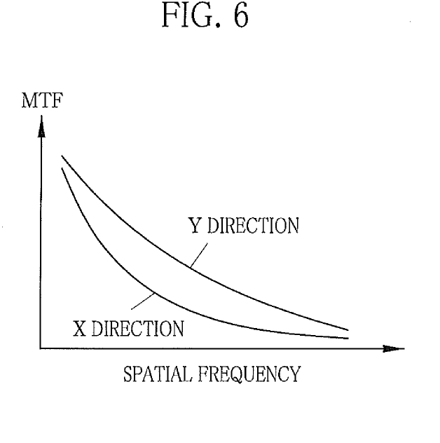

The X-ray image detector 20 is of an optical reading method. The size of the pixel in the Y direction (the main pixel size Dy) is physically determined by the transparent linear electrode 36a and the light-shielding linear electrode 36b. On the other hand, the size of the pixel in the X direction (the sub-pixel size Dx) is determined by a scanning width of the reading light LR. Accordingly, as shown in FIG. 6, MTF (Modulation Transfer Function) properties, relative to the spatial frequency, are different between the X and Y directions within the detection surface 20a of the X-ray image detector 20. FIG. 6 shows that the sharpness in the Y direction is higher than that in the X direction.

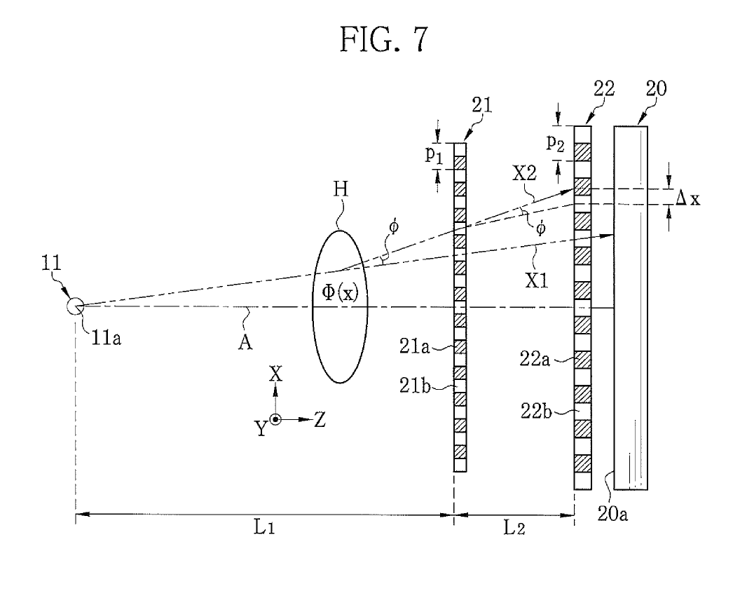

In FIG. 7, the X-ray source 11 emits the X-rays, being cone-shaped X-ray beams, from an X-ray focal point 11a, being a light emission point. The first grating 21 is configured to project the X-rays, passed through the X-ray transmitting portions 21b, in a substantially geometrical-optical manner. To be more specific, a width of the X-ray transmitting portion 21b in the X direction is set sufficiently larger than an effective wavelength of the X-rays emitted from the X-ray source 11. Thereby, most of the X-rays pass through the first grating 21 linearly without diffraction. For example, when tungsten is used for a rotating anode of the X-ray source 11 and a tube voltage is set to 50 kV, the effective wavelength of the X-rays is approximately 0.4 [symbol] . In this case, the width of the X-ray transmitting portion 21b is of the order of 1 μm to 10 μm. Note that the second grating 22 is similar to the first grating 21.

The G1 image, generated by the first grating 21, is enlarged in proportion to a distance from the X-ray focal point 11a. A grating pitch p₂ of the second grating 22 is set so as to coincide with the periodic pattern of the G1 image at the second grating 22. To be more specific, the grating pitch p₂ of the second grating 22 is set to substantially satisfy an expression (1), where p₁ denotes a grating pitch of the first grating 21, L₁ denotes a distance between the X-ray focal point 11a and the first grating 21, and L₂ denotes a distance between the first grating 21 and the second grating 22.

$${p}_{2} = \frac{{L}_{1} + {L}_{2}}{{L}_{1}} {p}_{1} \qquad ( 1 )$$

When the subject H is placed between the X-ray source 11 and the first grating 21, the G2 image is modulated by the subject H. An amount of the modulation reflects an angle of refraction of the X-rays refracted by the subject H.

Next, a method for producing a differential phase image is described. Coordinates x, y, z denote those in the X, Y, and Z directions, respectively. By way of example, FIG. 7 shows a path of the X-rays refracted in accordance with a phase shift distribution Φ(x) of the subject H. In the absence of the subject H, the X-rays travel linearly in a path “X1”. In this case, the X-rays pass the first and second gratings 21 and 22 and then are incident on the X-ray image detector 20. When the subject H is placed between the X-ray source 11 and the first grating 21, the X-rays travel in a path “X2” due to the refraction by the subject H. In this case, the X-rays in the path “X2” pass the first grating 21, but are incident on and absorbed by the X-ray absorbing portion 22a of the second grating 22.

The phase shift distribution Φ(x) of the subject H is represented by an expression (2), where n(x, z) denotes a refractive index distribution of the subject H. For the sake of simplification, the y coordinate is omitted.

$$Φ ( x ) = \frac{2 π}{λ} \int [ 1 - n ( x , z ) ] d z \qquad ( 2 )$$

Due to the refraction of the X-rays caused by the subject H, the G1 image formed at the second grating 22 is shifted or displaced in the X direction by an amount corresponding to the refraction angle φ. A displacement amount Δx is represented substantially by an expression (3) because the refraction angle φ of the X-rays is minute.

Δx≈L₂φ (3)

The refraction angle φ is represented by an expression (4) using the wavelength λ of the X-rays and the phase shift distribution Φ(x) of the subject H.

$$φ = \frac{λ}{2 π} \frac{\partial Φ ( x )}{\partial x} \qquad ( 4 )$$

As described above, the displacement amount Δx relates to the phase shift distribution Φ(x) of the subject H. The displacement amount Δx and the refraction angle φ relate to a phase shift amount ψ of the intensity modulated signal of each pixel detected by the X-ray image detector 20 in a manner represented by an expression (5) below. The phase shift amount ψ refers to an amount of the phase shift of the intensity modulated signal between the presence and absence of the subject H. The intensity modulated signal refers to a waveform signal representing intensity changes of a pixel value caused by positional changes between the first grating 21 and the second grating 22.

$$ψ = \frac{2 π}{{p}_{2}} Δ x = \frac{2 π}{{p}_{2}} {L}_{2} φ \qquad ( 5 )$$

The expressions (4) and (5) show that the phase shift amount ψ of the intensity modulated signal corresponds to a differential amount of the phase shift distribution Φ(x). The differential amount is integrated with respect to “x”. Thereby, the phase shift distribution Φ(x), being the phase contrast image, is produced.

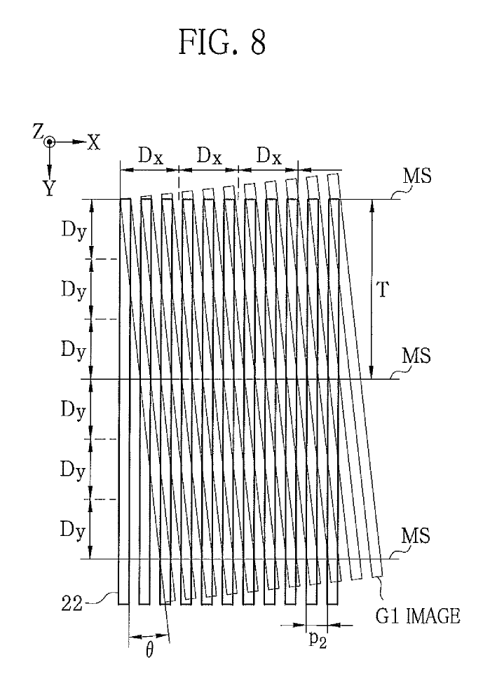

In FIG. 8, the first grating 21 is inclined at a predetermined angle θ about the Z axis relative to the second grating 22 such that the G1 image is inclined at the angle θ about the Z axis relative to the second grating 22. Thereby, moiré fringes MS with a period T (hereinafter referred to as the moiré period T) represented by an expression (6) are generated substantially in the Y direction in the G2 image.

$$T = \frac{{p}_{2}}{tan θ} \qquad ( 6 )$$

An inclination angle θ of the second grating 22 is set such that the moiré period T is substantially equivalent to integral multiple of the main pixel size Dy.

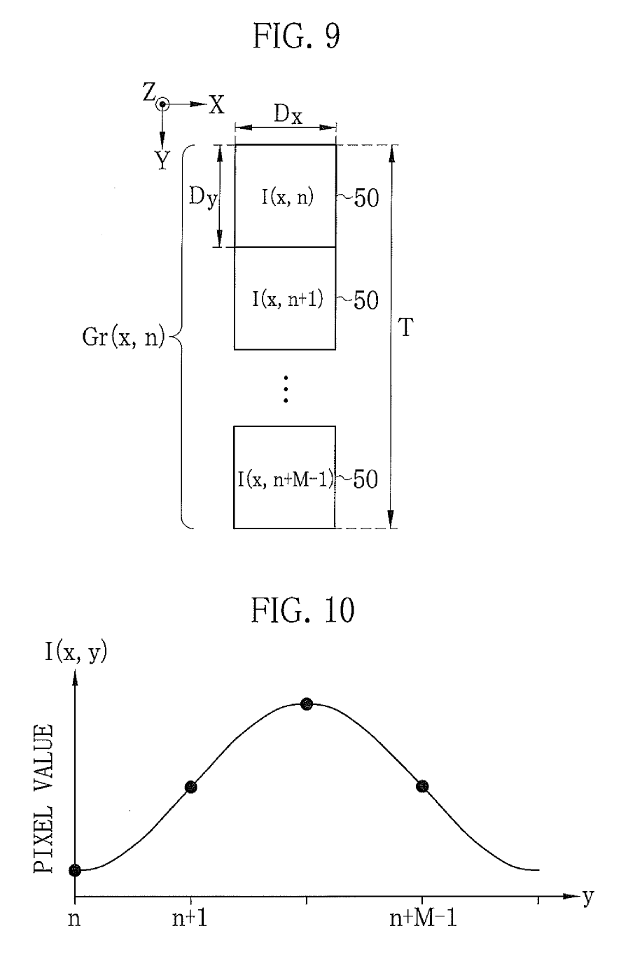

In FIG. 9, “M” number of pixels 50 arranged in the Y direction are grouped into a group “Gr(x, n)”, where “M” denotes a positive integer and “n” denotes a positive integer. The “n” represents a y coordinate of the first pixel 50 in the group “Gr(x, n)”. In this embodiment, the “ν” number of pixels in the group “Gr(x, n)” is equivalent to the “ν” number of pixels included in or corresponding to the single moiré period T (In the example shown in FIG. 8, ν=3).

“I(x, y)” denotes a pixel value of the pixel 50 at the coordinates (x, y). The pixel value I (x, y) is obtained from the image data stored in the memory 13. As shown in FIG. 10, the pixel values I(x, n) to I(x, n+M−1) of the respective pixels 50 in the group Gr(x, n) constitute an intensity modulated signal of one period, because an amount of the intensity modulation in each pixel 50, modulated by the second grating 22, is different depending on the y coordinate of the pixel 50. Accordingly, the pixel values I (x, n) to I (x, n+M−1) in the group Gr (x, n) correspond to the intensity modulated signal of the single period obtained using the conventional fringe scanning method in which an image is captured every time one of the first and second gratings is moved for a predetermined distance in a direction (X direction) substantially perpendicular to a grating direction.

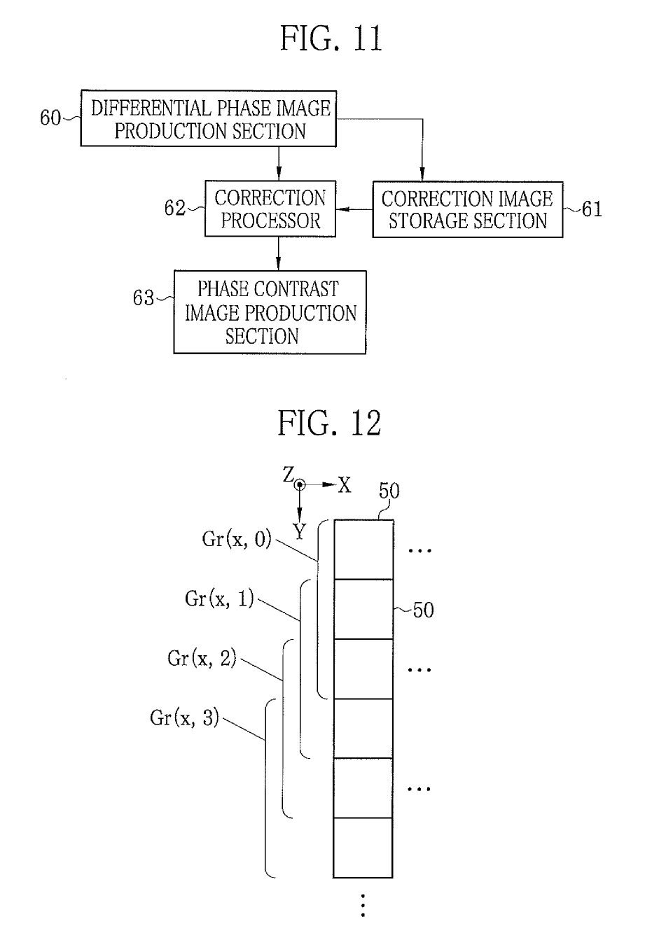

In FIG. 11, the image processor 14 is provided with a differential phase image production section 60, a correction image storage section 61, a correction processor 62, and a phase contrast image production section 63. The differential phase image production section 60 reads out each of image data, obtained by the preliminary imaging and the actual imaging and stored in the memory 13, and produces the differential phase images using a method which will be described later. The correction image storage section 61 stores a differential phase image, being a correction image, produced from the image data obtained by the preliminary imaging. The correction processor 62 subtracts the correction image, stored in the correction image storage section 61, from the differential phase image produced from the image data obtained by the actual imaging. Thereby, the correction processor 62 produces a corrected differential phase image. The phase contrast image production section 63 integrates the corrected differential phase image in the X direction to produce the phase contrast image.

As shown in FIG. 12, the differential phase image production section 60 shifts the group Gr(x, n) in the Y direction by one pixel at a time (namely, the “n” is increased by an increment of 1) in each column (arranged in the X direction) of the pixels 50, to calculate the differential phase value based on the intensity modulated signal of each group Gr (x, n). The differential phase image is obtained by calculating the differential phase value of every pixel 50.

The differential phase value can be calculated in a manner similar to the fringe scanning method. To be more specific, a method for calculating phase distribution using a phase modulation interference method (fringe scanning interference method) disclosed in “Applied Optics-Introduction to Optical Measurement” (T. Yatagai, published by Maruzen, pages 136 to 138) is used.

The differential phase image production section 60 calculates a determinant (7) below, and applies a calculation result to a subsequent expression (8). Thereby, the differential phase image production section 60 obtains the differential phase value ψ(x, y).

$$\begin{matrix}a = {A}^{- 1} ( {δ}_{k} ) B ( {δ}_{k} ) & ( 7 ) \\ ψ ( x , n ) = - {tan}^{- 1} \frac{{a}_{2}}{{a}_{1} } & ( 8 )\end{matrix}$$

A reference phase δₖ, matrices “a”, A(δₖ), and B(δₖ) are represented by respective expressions (9) to (12) below.

$$\begin{matrix} {δ}_{k} = 2 π \frac{k}{v} & ( 9 ) \\ a = ( \begin{matrix}{a}_{0} \\ {a}_{1} \\ {a}_{2}\end{matrix} ) & ( 10 ) \\ A ( {δ}_{k} ) = ( \begin{matrix}1 & \frac{1}{M} {\sum }_{k = 0}^{M - 1} cos {δ}_{k} & \frac{1}{M} {\sum }_{k = 0}^{M - 1} sin {δ}_{k} \\ \frac{1}{M} {\sum }_{k = 0}^{M - 1} cos {δ}_{k} & \frac{1}{M} {\sum }_{k = 0}^{M - 1} {cos}^{2} {δ}_{k} & \frac{1}{M} {\sum }_{k = 0}^{M - 1} cos {δ}_{k} sin {δ}_{k} \\ \frac{1}{M} {\sum }_{k = 0}^{M - 1} sin {δ}_{k} & \frac{1}{M} {\sum }_{k = 0}^{M - 1} cos {δ}_{k} sin {δ}_{k} & \frac{1}{M} {\sum }_{k = 0}^{M - 1} {sin}^{2} {δ}_{k}\end{matrix} ) & ( 11 ) \\ B ( {δ}_{k} ) = ( \begin{matrix}\frac{1}{M} {\sum }_{k = 0}^{M - 1} I ( x , n + k ) \\ \frac{1}{M} {\sum }_{k = 0}^{M - 1} I ( x , n + k ) cos {δ}_{k} \\ \frac{1}{M} {\sum }_{k = 0}^{M - 1} I ( x , n + k ) sin {δ}_{k}\end{matrix} ) & ( 12 )\end{matrix}$$

In this embodiment, because M equals ν (M=ν), the reference phase δₖ gradually changes at regular intervals between 0 to 2π. In this case, a non-diagonal term of the matrix A(δₖ) is 0, and a diagonal term other than 1 is ½. Accordingly, the differential phase value ψ(x, y) can be calculated using a simpler expression (13).

$$ψ ( x , n ) = - {tan}^{- 1} \frac{{\sum }_{k = 0}^{M - 1} I ( x , n + k ) sin {δ}_{k}}{{\sum }_{k = 0}^{M - 1} I ( x , n + k ) cos {δ}_{k}} \qquad ( 13 )$$

Next, an operation of the above-configured X-ray imaging apparatus 10 is described. First, the preliminary imaging without the subject H present is commanded by the operation unit 17a. In response to this, the X-ray source 11 emits the X-rays. The X-ray image detector 20 detects the G2 image and produces the image data. The image data is stored in the memory 13. Then, the image processor 14 reads out the image data from the memory 13. In the image processor 14, the differential phase image production section 60 performs the above-described calculation based on the image data to produce the differential phase image. The differential phase image, being the correction image, is stored in the correction image storage section 61. This ends the preliminary imaging.

Thereafter, the subject H is placed between the X-ray source 11 and the first grating 21. When the operation unit 17a commands the actual imaging, the X-ray source 11 emits the X-rays, and the X-ray image detector 20 detects the G2 image. Thereby, the image data is produced. The image data is stored in the memory 13. Then, the image processor 14 reads out the image data from the memory 13. In the image processor 14, the differential phase image production section 60 performs the above-described calculation based on the image data to produce the differential phase image.

The differential phase image is inputted from the differential phase image production section 60 to the correction processor 62. The correction processor 62 reads out the correction image from the correction image storage section 61, and subtracts the correction image from the differential phase image inputted from the differential phase image production section 60. Thereby, the corrected differential phase image, reflecting or carrying only the phase information of the subject H, is produced. The corrected differential phase image is inputted to the phase contrast image production section 63, and then integrated in the X direction. Thereby, the phase contrast image is produced.

The phase contrast image and the corrected differential phase image are stored in the image storage section 15, and then inputted to the console 17 and displayed on the monitor 17b.

In this embodiment, the direction of the period of the moiré fringes (the direction orthogonal to the fringes) corresponds to or coincides with the direction with the high sharpness, being the Y direction, of the X-ray image detector 20. This improves the contrast of the moiré fringes detected by the X-ray image detector 20. Accordingly, the intensity modulated signal is obtained with high accuracy. As result, an S/N of the differential phase image improves.

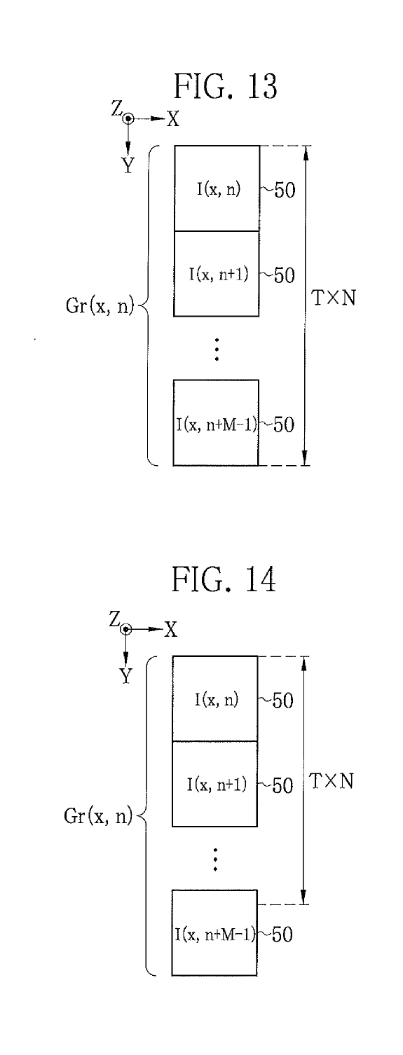

In the first embodiment, as shown in FIG. 9, the M number of the pixels in one group Gr (x, n) is equivalent to the ν number of pixels included in the single moiré period T. Alternatively, as shown in FIG. 13, the M number of the pixels in one group Gr(x, n) may be equivalent to a multiple of N (an integer of two or more) times the ν number of pixels included in the single moiré period T.

As shown in FIG. 14, the M number of the pixels in one group Gr (x, n) may not be equivalent to the ν number of pixels included in the single moiré period T or its multiple of N times. In this case, the expression (13) cannot be used for calculating the differential phase value ψ(x, y). Instead, the calculation result of the determinant (7) is applied to the expression (8) to obtain the differential phase value ψ(x, y).

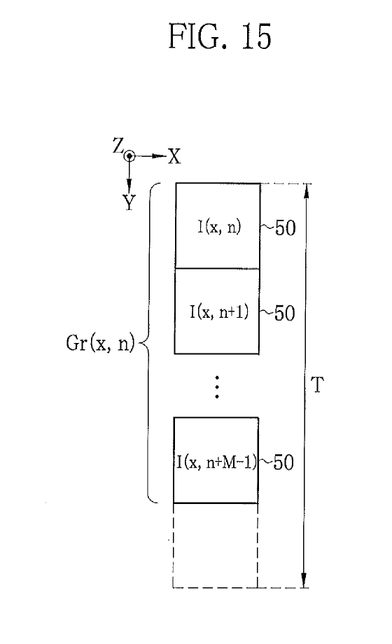

As shown in FIG. 15, the M number of the pixels in one group Gr(x, n) may be less than the ν number of the pixels included in the single moiré period T. Also in this case, the expression (13) cannot be used for calculating the differential phase value ψ(x, y). Instead, the calculation result of the determinant (7) is applied to the expression (8) to obtain the differential phase value ψ(x, y). Because the number of the pixels used for calculating the differential phase value is less than that in the first embodiment, the S/N ratio becomes lower than that in the first embodiment, while the resolution improves.

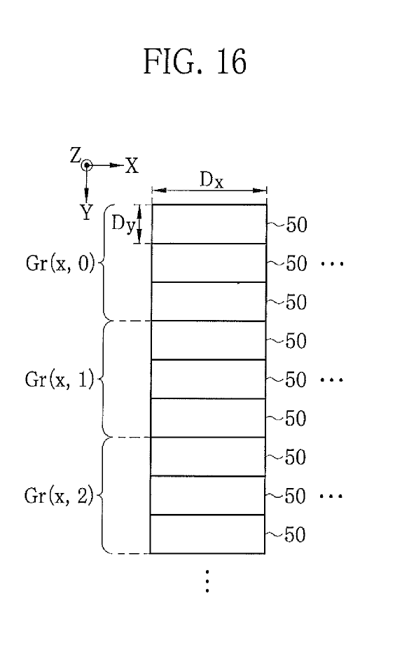

In the first embodiment, as shown in FIG. 12, the differential phase value is calculated using the group Gr(x, n) shifted or changed in the Y direction by one pixel at a time. The group Gr(x, n) may be shifted in the Y direction by two or more pixels at a time to calculate the differential phase value. Furthermore, as shown in FIG. 16, the group Gr(x, n), composed of M number of pixels, may be shifted by the M number of pixels at a time to calculate the differential phase value. In this case, it is preferable to configure the X-ray image detector 20 such that the size of the pixel 50 satisfies the condition Dx=M×Dy.

In the first embodiment, the X-ray absorbing portions 22a of the second grating 22 extend in the Y direction. The extending direction of the X-ray absorbing portions 21a of the first grating 21 is inclined by the angle θ relative to the Y direction. Conversely, the X-ray absorbing portions 21a of the first grating 21 may extend in the Y direction, and the extending direction of the X-ray absorbing portions 22a of the second grating 22 may be inclined by the angle θ relative to the Y direction. Alternatively, the X-ray absorbing portions 21a of the first grating 21 and the X-ray absorbing portions 22a of the second grating 22 may be inclined in opposite directions relative to the Y direction to form the angle θ. In other words, one of the first and second gratings 21 and 22 may be placed in a rotated state relative to the other, while a grating surface of the first or second grating 21 or 22 is kept in parallel with the other.

In the first embodiment, the X-ray image detector 20 is disposed behind and close to the second grating 22 to detect the G2 image, produced by the second grating 22, of equal magnification. Alternatively, the second grating 22 may be disposed away from the X-ray image detector 20. When “L₃” denotes a distance between the X-ray image detector 20 and the second grating 22 in the Z direction, the X-ray image detector 20 detects the G2 image enlarged with the magnification R of an expression (14).

$$R = \frac{{L}_{1} + {L}_{2} + {L}_{3}}{{L}_{1} + {L}_{2}} \qquad ( 14 )$$

In this case, a period T′ of the moiré fringes detected by the X-ray image detector 20 is a multiple of R times the moiré period T of the expression (6) (that is, T′=RT). Accordingly, the group Gr(x, n) is set based on the moiré period T′.

In the first embodiment, the differential phase value refers to the value represented by the expression (8) or (13), that is, a value representing the phase of the intensity modulated signal. Alternatively, the value representing the phase of the intensity modulated signal may be multiplied by a constant, or added to a constant to be used as the differential phase value.

In the first embodiment, the differential phase image is produced. Alternatively or in addition, an absorption image or a small angle scattering image can be produced. The absorption image can be produced by obtaining an average of the intensity modulated signal shown in FIG. 10 by way of example. The small angle scattering image can be produced by obtaining amplitude of the intensity modulated signal.

In the first embodiment, the subject H is placed between the X-ray source 11 and the first grating 21. Alternatively, the subject H may be placed between the first grating 21 and the second grating 22.

In the first embodiment, the cone-shaped X-ray beams are emitted from the X-ray source 11. Alternatively, an X-ray source which emits parallel beams may be used. In this case, the first and second gratings 21 and 22 are configured to substantially satisfy p₂=p₁, instead of the expression (1).

In the first embodiment, the X-ray image detector 20 of the optical reading method is used. The present invention can also be applied to an X-ray image detector which electrically reads out charge through switching elements such as TFTs and an X-ray imaging apparatus using an imaging plate, as long as the device or apparatus has a difference in sharpness between the two orthogonal directions within its detection surface.

### Second Embodiment

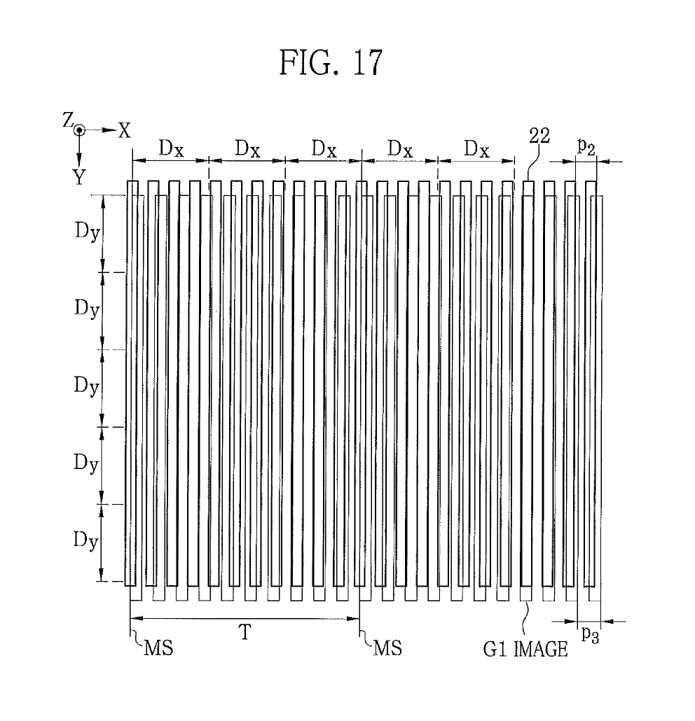

Next, a second embodiment of the present invention is described. In the first embodiment, to cause moiré fringes in the G2 image, one of the first and second gratings 21 and 22 is inclined relatively to the other in the direction within the grating plane. In the X-ray imaging apparatus of the second embodiment, on the other hand, the first and second gratings 21 and 22 are not inclined. Instead, a positional relation between the first and second gratings 21 and 22 (the distances L₁ and L₂), or the grating pitches p₁ and p₂ of the first and second gratings 21 and 22 are adjusted to be slightly different from the expression (1). Thereby, the moiré fringes are generated in the G2 image as shown in FIG. 17.

The pattern period p₃ in the X direction of the G1 image in the position of the second grating 22 is slightly shifted from the grating pitch p₂ of the second grating 22. The moiré fringes have a period T, in the X direction, represented by an expression (15).

$$T = \frac{{p}_{2} {p}_{3 }}{\vert {p}_{2} - {p}_{3} \vert} \qquad ( 15 )$$

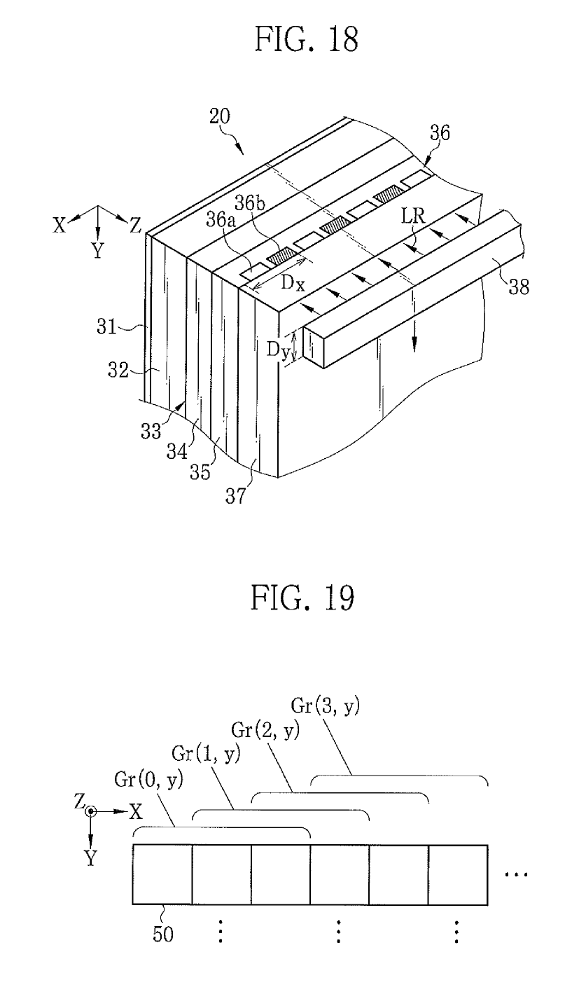

In this embodiment, as described above, the direction of the period of the moiré fringes is in the X direction. Accordingly, as shown in FIG. 18, the X-ray image detector 20 is disposed such that the transparent linear electrodes 36a and the light-shielding linear electrodes 36b extend in the Y direction, and the linear reading light source 38 extends in the X direction. Thereby, in the X-ray image detector 20, the direction with high sharpness is in the X direction, and the direction with low sharpness is in the Y direction.

In this embodiment, as shown in FIG. 19, the differential phase image production section 60 calculates the differential phase value ψ(x, y) based on the intensity modulated signal of each group Gr(n, y), and the group Gr(n, y) is shifted in the X direction by one pixel at a time (namely, the “n” is increased by an increment of 1) in each row (arranged in the Y direction) of the pixels 50.

The differential phase value ψ(x, y) is calculated in a similar manner to the first embodiment. To be more specific, to calculate the differential phase value ψ(x, y) using the calculation result of the determinant (7), an expression (16) is used instead of the expression (8), and an expression (17) is used instead of the expression (12).

$$\begin{matrix}ψ ( n , y ) = - {tan}^{- 1} \frac{{a}_{2}}{{a}_{1}} & ( 16 ) \\ B ( {δ}_{k} ) = ( \begin{matrix}\frac{1}{M} {\sum }_{k = 0}^{M - 1} I ( n + k , y ) \\ \frac{1}{M} {\sum }_{k = 0}^{M - 1} I ( n + k , y ) cos {δ}_{k} \\ \frac{1}{M} {\sum }_{k = 0}^{M - 1} I ( n + k , y ) sin {δ}_{k}\end{matrix} ) & ( 17 )\end{matrix}$$

When the moiré period T is set to an approximate integral multiple of the main pixel size Dx, the differential phase value ψ(x, y) is obtained with the use of an expression (18) instead of the expression (13).

$$ψ ( n , y ) = - {tan}^{- 1} \frac{{\sum }_{k = 0}^{M - 1} I ( n + k , y ) sin {δ}_{k}}{{\sum }_{k = 0}^{M - 1} I ( n + k , y ) cos {δ}_{k}} \qquad ( 18 )$$

In this embodiment, similar to the first embodiment, the M number of the pixels in one group Gr (n, y) may not necessarily be equivalent to the ν number of the pixels included in the single moiré period T or its multiple of N times. The M may be less than the ν. The differential phase value may be calculated using the group Gr (n, y) shifted by two or more pixels at a time in the X direction. Configuration and operation other than those described above are similar to those in the first embodiment.

In this embodiment, the distance between the X-ray image detector 20 and the second grating 22 may be set to L₃. In this case, the group Gr (n, y) is set based on the moiré period T′, being the moiré period T represented by the expression (15) multiplied by the magnification R represented by the expression (14).

The moiré fringes with a period not in parallel with either the X direction or the Y direction may be generated in the G2 image due to the combination of the relative inclination of the first and second gratings 21 and 22 in the direction within the grating plane described in the first embodiment and the positional relation between the first and second gratings 21 and 22 and/or the shift of the grating pitch described in the second embodiment. Even so, the differential phase image is produced using one of the methods described in the first and second embodiments because the moiré fringes have components both in the X and Y directions. Additionally, the group of pixels 50 may be formed in an oblique direction not in parallel with either the X direction or the Y direction to produce the differential phase image in a manner similar to the above.

### Third Embodiment

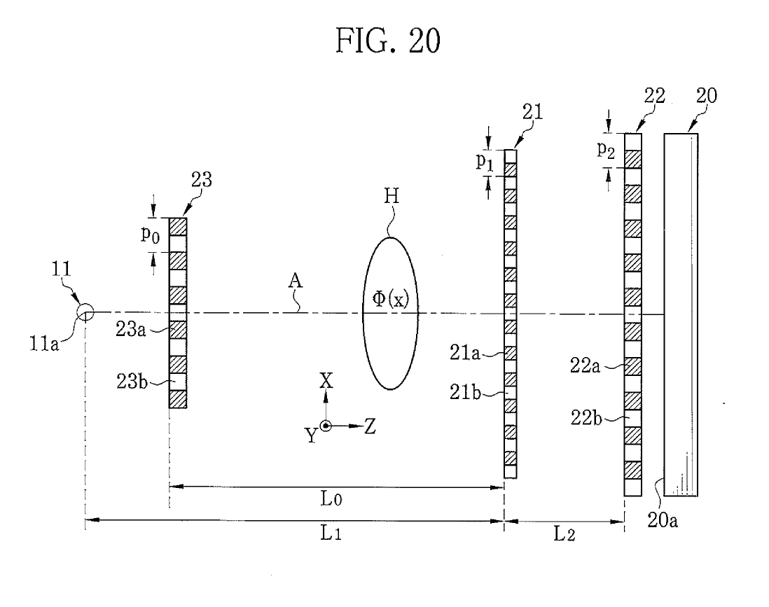

Next, a third embodiment of the present invention is described. In the first and second embodiments, the X-ray source 11 has the single focal point. On the other hand, in the third embodiment, as shown in FIG. 20, a multi-slit (source grating) disclosed in, for example, WO2006/131235 is disposed immediately in front of the X-ray source 11 on the emission side. Similar to the first and second gratings 21 and 22, the multi-slit 23 has a plurality of the X-ray absorbing portions 23a and a plurality of the X-ray transmitting portions 23b, extending in the Y direction and arranged alternately in the X direction. The grating pitch p₀ of the multi-slit 23 is set to substantially satisfy an expression (19), where “L₀” denotes a distance between the multi-slit 23 and the first grating 21.

$${p}_{0} = \frac{{L}_{0}}{{L}_{2}} {p}_{2} \qquad ( 19 )$$

With this configuration, the radiation from the X-ray source 11 is dispersed in the Y direction such that each X-ray transmitting portion 23b functions as the X-ray focal point. The radiation emitted from each X-ray transmitting portion 23b passes through the first grating 21 to form the G1 image. The G1 images are overlapped with each other in the position of the second grating 22 to form the G2 image. This increases the light quantity of the G2 image, and improves accuracy in the calculation of the differential phase image, and reduces the imaging time.

The configuration and operation other than those described above are similar to those in the first or second embodiments. Because each X-ray transmitting portion 23b of the multi-slit 23 functions as the X-ray focal point in this embodiment, the distance L₀ replaces the distance L₁ in the expression (1).

In this embodiment, the distance between the X-ray image detector 20 and the second grating 22 may be set to L₃. In this case, the group Gr(x, n) or the group Gr(n, y) may be set based on the moiré period T′, being the moiré period T represented by the expression (6) or (15) multiplied by the magnification R of the expression (14). Note that even if the multi-slit 23 is used, the G2 image produced by the second grating 22 is enlarged in proportion to the distance between the X-ray focal point 11a of the X-ray source 11 and the X-ray image detector 20. Accordingly, the magnification R of the expression (14) is used without replacing the L₁ with the L₀.

### Fourth Embodiment

Next, a fourth embodiment of the present invention is described. In the first to third embodiments, the first grating 21 projects the incident X-rays in the geometrical-optical manner without diffraction. In an X-ray imaging apparatus of the fourth embodiment, the first grating 21 produces Talbot effect as described in Japanese Patent Laid-Open Publication No. 2008-200361, for example. To produce the Talbot effect with the first grating 21, an X-ray source of a small focal point is used to increase spatial interference of the X-rays or the multi-slit 23 is used to reduce the size of the focal point.

When the first grating 21 produces the Talbot effect, a self image (the G1 image) of the first grating 21 is formed downstream from the first grating 21 at a Talbot distance Zₘ away from the first grating 21. In other words, in this embodiment, the distance L₂ between the first grating 21 and the second grating 22 needs to be set to the Talbot distance Zₘ. In this case, a phase grating may be used for the first grating 21. Note that other configuration and operation other than those described in this embodiment are similar to those described in the first, second, or third embodiments.

When the first grating 21 is the absorption grating and the X-ray source 11 emits the cone-shaped X-ray beams, the Talbot distance Zₘ is represented by an expression (20), where “m” is a positive integer. In this case, the grating pitches p₁ and p₂ are set to substantially satisfy the expression (1). Note that when the multi-slit 23 is used, the distance L₀ replaces the distance L₁.

$${Z}_{m} = m \frac{{p}_{1} {p}_{2}}{λ} \qquad ( 20 )$$

When the first grating 21 is the phase grating that modulates the phase by π/2, and the X-ray source 11 emits the cone-shaped X-ray beams, the Talbot distance Zₘ is represented by an expression (21), where “m” is “0” or a positive integer. In this case, the grating pitches p₁ and p₂ are set to substantially satisfy the expression (1). Note that when the multi-slit 23 is used, the distance L₀ replaces the distance L₁.

$${Z}_{m} = ( m + \frac{1}{2} ) \frac{{p}_{1} {p}_{2}}{λ} \qquad ( 21 )$$

When the first grating 21 is the phase grating that modulates the phase by n, and the X-ray source 11 emits the cone-shaped X-ray beams, the Talbot distance Zₘ is represented by an expression (22), where “m” is “0” or a positive integer. In this case, the pattern period of the G1 image is half the grating period of the first grating 21. Accordingly, the grating pitches p₁ and p₂ are set to satisfy an expression (23). Note that when the multi-slit 23 is used, the distance L₀ replaces the distance L₁.

$$\begin{matrix}{Z}_{m} = ( m + \frac{1}{2} ) \frac{{p}_{1} {p}_{2}}{2 λ} & ( 22 ) \\ {p}_{2} = \frac{{L}_{1} + {L}_{2}}{{L}_{1}} \frac{{p}_{1}}{2} & ( 23 )\end{matrix}$$

When the first grating 21 is the absorption grating, and the X-rays from the X-ray source 11 are parallel beams, the Talbot distance Zₘ is represented by an expression (24), where “m” is a positive integer. In this case, the grating pitches p₁ and p₂ are set to substantially satisfy the relation p₂=p₁.

$${Z}_{m} = m \frac{{p}_{1}^{2}}{λ} \qquad ( 24 )$$

When the first grating 21 is the phase grating that modulates the phase by π/2, and the X-rays from the X-ray source 11 are the parallel beams, the Talbot distance Zₘ is represented by an expression (25), where “m” is “0” or a positive integer. In this case, the grating pitches p₁ and p₂ are set to substantially satisfy the relation p₂=p₁.

$${Z}_{m} = ( m + \frac{1}{2} ) \frac{{p}_{1}^{2}}{λ} \qquad ( 25 )$$

When the first grating 21 is the phase grating that modulates the phase by n, and the X-rays from the X-ray source 11 are the parallel beams, the Talbot distance Zₘ is represented by an expression (26), where “m” is “0” or a positive integer. In this case, the pattern period of the G1 image is half the grating period of the first grating 21. Accordingly, the grating pitches p₁ and p₂ are set to substantially satisfy the relation p₂=p₁/2.

$${Z}_{m} = ( m + \frac{1}{2} ) \frac{{p}_{1}^{2}}{4 λ} \qquad ( 26 )$$

### Fifth Embodiment

Next, a fifth embodiment of the present invention is described. In the first to fourth embodiments, the differential phase image production section 60 sets the group Gr (x, n) in each column (arranged in the X direction) of the pixels 50, and produces the differential phase image in a manner similar to the fringe scanning method with the group Gr (x, n) shifted in the Y direction. Alternatively, in an X-ray imaging apparatus of the fifth embodiment, the image data is subjected to Fourier transform, extraction of a spectrum corresponding to a carrier frequency, and inverse Fourier transform, as described in the U.S. Patent Application Publication No. 2011/0158493. Thereby, the differential phase image is produced.

In this embodiment, to generate the moiré fringes in the G2 image, the first and second gratings 21 and 22 may be inclined relative to each other in a direction within the grating plane as described in the first embodiment. Additionally, the positional relation between the first and second gratings 21 and 22 or the grating pitches p₁ and p₂ of the first and second gratings 21 and 22 may be adjusted to be slightly different from the expression (1) as described in the second embodiment. In this embodiment, the direction of the period of the moiré fringes corresponds to or coincides with the direction with high sharpness within the detection surface 20a of the X-ray image detector 20. This improves the contrast of the moiré fringes detected by the X-ray image detector 20. Accordingly, the above-described processing steps are performed with high accuracy. As result, the S/N of the differential phase image improves.

The above embodiments can be combined with each other while contradictions are avoided. The present invention can be applied to the radiation apparatus for use in medical diagnoses and for industrial use. For the radiation, gamma rays can be used instead of the X-rays.

Various changes and modifications are possible in the present invention and may be understood to be within the present invention.

What is claimed is:

1. A radiation imaging apparatus comprising:
a first grating for passing radiation, from a radiation source, to generate a first periodic pattern image;
a second grating facing the first grating, the second grating partly shielding the first periodic pattern image to generate a second periodic pattern image with moiré fringes;
a radiation image detector having a plurality of pixels arranged in a plane with a first direction and a second direction orthogonal to each other, the radiation image detector detecting the second periodic pattern image, using the pixels, to produce image data, the radiation image detector being disposed such that the first direction with high sharpness crosses the moiré fringes;
a differential phase image production section for producing a differential phase image based on the image data.

2. The radiation imaging apparatus of claim 1, wherein the radiation image detector is of an optical reading type and has a linear reading light source extending in the first direction, and the radiation image detector reads out charge, accumulated in each of the pixels arranged in the first direction, being a pixel value of one line, with the use of the linear reading light source that scans in the second direction orthogonal to the first direction.

3. The radiation imaging apparatus of claim 1, wherein the differential phase image production section uses predetermined number of the pixels arranged in the first direction as a group and shifts the group by one or more pixels at a time in the first direction to calculate phase of an intensity modulated signal, composed of the pixel values in each group, to produce the differential phase image.

4. The radiation imaging apparatus of claim 3, wherein the group is shifted by one pixel.

5. The radiation imaging apparatus of claim 4, wherein the number of the pixels constituting the group is equivalent to an integral multiple of number of pixels corresponding to a single period of the moiré fringes.

6. The radiation imaging apparatus of claim 5, wherein the number of the pixels constituting the group is equivalent to the number of pixels corresponding to the single period of the moiré fringes.

7. The radiation imaging apparatus of claim 3, wherein the number of the pixels constituting the group is less than number of pixels corresponding to a single period of the moiré fringes.

8. The radiation imaging apparatus of claim 1, wherein the differential phase image production section performs Fourier transform, extraction of a spectrum corresponding to a carrier frequency, and inverse Fourier transform to the image data to produce the differential phase image.

9. The radiation imaging apparatus of claim 1, wherein the moiré fringes are generated by placing the second grating in a rotated state relative to the first grating, while a grating surface of the second grating is kept in parallel with the first grating, and the moiré fringes are substantially orthogonal to grating directions of the first and second gratings.

10. The radiation imaging apparatus of claim 1, wherein the moiré fringes are generated by adjusting a distance between the first grating and the radiation source and a distance between the second grating and the radiation source, or a grating pitch of each of the first and second gratings, and the moiré fringes are substantially in parallel with a grating direction of the first and second gratings.

11. The radiation imaging apparatus of claim 1, wherein the moiré fringes are generated by placing the second grating in a rotated state relative to the first grating, while a grating surface of the second grating is kept in parallel with the first grating, and by adjusting a positional relation between the first and second gratings in a facing direction, or by adjusting a grating pitch of each of the first and second gratings, and the moiré fringes are not orthogonal to and not in parallel with grating directions of the first and second gratings.

12. The radiation imaging apparatus of claim 1, further including a phase contrast image production section for integrating the differential phase image, in a direction substantially orthogonal to grating directions of the first and second gratings, to produce a phase contrast image.

13. The radiation imaging apparatus of claim 1, further including:
a correction image storage section for storing a differential phase image, produced based on the image data obtained without the subject, as a correction image; and
a correction processor for subtracting the correction image from the differential phase image produced based on the image data obtained with the subject.

14. The radiation imaging apparatus of claim 13, further including a phase contrast image producing section for integrating a corrected differential phase image, corrected by the correction processor, in a direction substantially orthogonal to grating directions of the first and second gratings to produce the phase contrast image.

15. The radiation imaging apparatus of claim 1, wherein the first grating is an absorption grating and the first grating projects the incident radiation to the second grating in a geometrical-optical manner to generate the first periodic pattern image.

16. The radiation imaging apparatus of claim 1, wherein the first grating is an absorption grating or a phase grating for producing Talbot effect so that the incident radiation generates the first periodic pattern image.

17. The radiation imaging apparatus of claim 1, further including a multi-slit disposed between the radiation source and the first grating, the multi-slit partly shielding the radiation to disperse a focal point.
